(19) United States
(12) Patent Application Publication
(10) Pub. No.: US 2003/0045190 A1
(43) Pub. Date: Mar. 6, 2003

(54) No-twist fabricated filtration screen

(76) Inventor: Michael Maguire, Way Cross, GA (US)

Correspondence Address: PILLSBURY WINTHROP, LLP, P.O. BOX 10500, MCLEAN, VA, 22102, US

(21) Appl. No.: 10/053,571

(22) Filed: Jan. 24, 2002

Related U.S. Application Data
(60) Provisional application No. 60/317,191, filed on Sep. 6, 2001.

(51) Int. Cl. D03D 9/00; D04B 1/00; D04C 1/00; D04B 21/00; D03D 15/00; B32B 5/26; B32B 5/12; B32B 15/14; D04H 1/00; D03D 19/00; D04G 1/00

(52) U.S. Cl. 442/6; 442/2; 442/49; 428/114; 442/185

(57) ABSTRACT

A filter screen is made of metal or synthetic strands having reinforcing filaments regularly spaced in the cross machine and the machine directions.

This application claims the benefit of Provisional Application No 60/317,191 filed Sep. 6, 2001.

### FIELD OF THE INVENTION

The field of the invention relates to filtration in the washing and bleaching processes in the preparation of pulp in the Paper Making Industry, and to forming screens used in the manufacture of air laid or wet laid fabrics from suspensions of fibrous raw materials, and to transportation screens used to move materials in sheet or non-woven fabric.

### BACKGROUND OF THE INVENTION

In many manufacturing processes raw material in the form of fibrous suspensions must be treated in various stages requiring support between and through stages. In the conventional system, transportation, forming, washing, bleaching and filtering of wood or synthetic fibers are carried out on a uniform screen which functions to both transport the material through the various processing stages and also to separate the suspended fibers from the carrier fluid which may include wash liquids with conditioning chemicals such as bleaching bases at elevated temperatures. In addition, the screen is subject to forces which may deform or change its shape.

In the past such screens have been made from uniformly woven fabric, either of metal or synthetic strands and seamed to form an endless surface. Unfortunately, with increasing demand for higher throughput and speed the screens can experience forces which cause them to change shape or rupture and foreshorten their useful life. As one result, the production costs are increased since the removal, repair and reinstallation of repaired or new screens is a time consuming and labor intensive process.

### SUMMARY OF THE INVENTION

The present invention is based on the discovery that the stability, durability and life of such screens can be greatly enhanced by employing manufacturing techniques which add stiffness to both the cross machine and to the machine directions of the fabric. Specifically the formation of a brazed or welded seam, at intervals, in the cross machine and machine directions, or the addition of stiff reinforcing strands at the same intervals, either in the weaving process or after the fabric has been manufactured, can greatly resist the twisting or deformation of the forming or carrier screens.

### BRIEF DESCRIPTION OF THE DRAWINGS

FIG. 1A is a view of a deformed screen as installed upon a washer or bleach drum in the pulp manufacturing process.

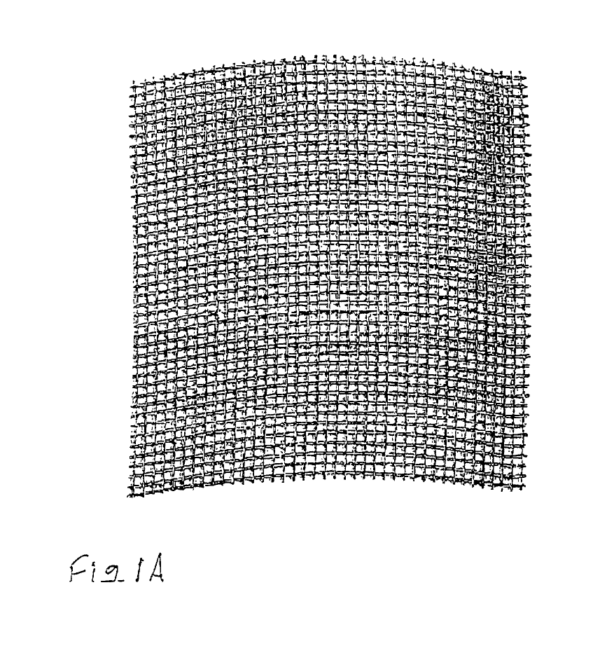

FIG. 1B is a view of a deformed screen used as a forming or transport belt.

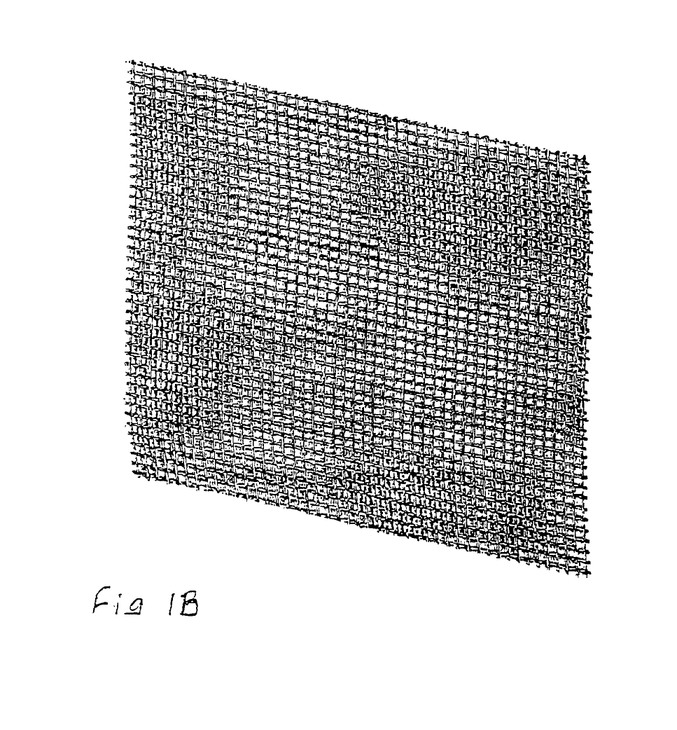

FIG. 2 is a view of a reinforced screen, subject to the same deforming forces, where brazed or welded seams, or stiff strands have been added during weaving or after the fabric has been manufactured.

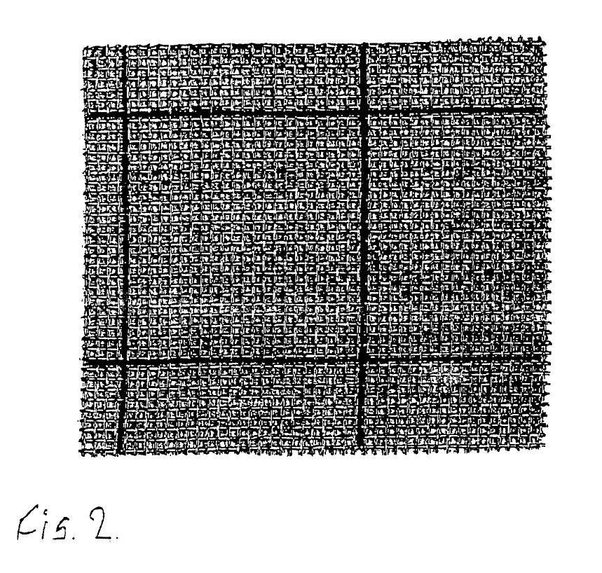

FIG. 3 is a view of a pulp washer.

FIG. 4 is a view of a forming machine employing a drum.

FIG. 5 is a view of a forming machine employing compression rollers.

FIG. 6 is a view of a transport section of a production machine.

In many if not all of the cellulose or synthetic based manufacturing processes both concentrations of fiber or particle suspensions and machine speeds are being pushed higher and higher to increase machine throughput. As a consequence, as noted above, the useful life of the screens is often terminated because deformation has precipitated catastrophic damage.

In order to resist the deforming forces, the fabric has been reinforced by introducing, at regular spacing in the cross machine and the machine direction, brazed or welded seams, or stiff strands, either woven in or added after manufacture of the fabric.

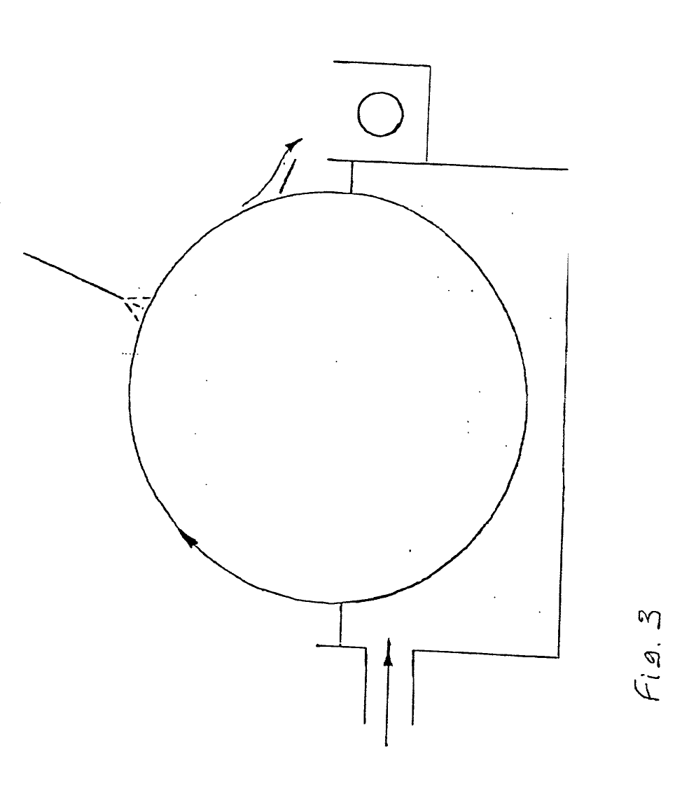

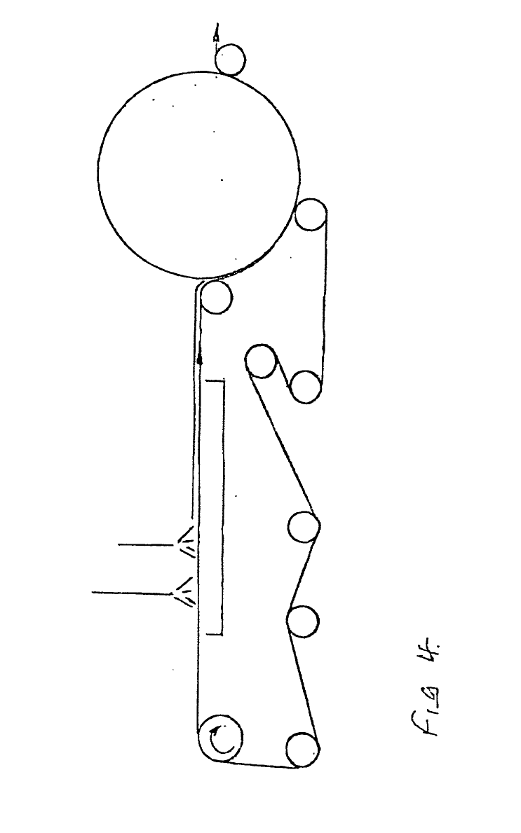

In practically all production facilities the filter screen is seamed to form an endless surface. A synthetic screen is either seamed and shrunk on a rotating cylinder, as illustrated in FIG. 3, or seamed and suspended over a plurality of rollers, one of which is driven to effect transport from one point of the production process to another point, as illustrated in FIG. 4, 5 and 6. A metal screen is either stretched and brazed, or welded, on the same type of cylinder, FIG. 3, or seamed and suspended over rollers as above, FIG. 4, 5 and 6.

When fitted to a cylinder a source of cellulose or other fibers deposits a heavy layer on the screen surface as shown in FIG. 3. The filter screen separates the fiber from the carrier fluid while transporting the layer around the machine. The fiber is removed from the screen with the aid of a blade. At high speed or excessive loading the forces generated by a build up of fiber at the blade may become sufficient to twist the screen on the cylinder, pulling it from under its edge retainers and causing a catastrophic failure.

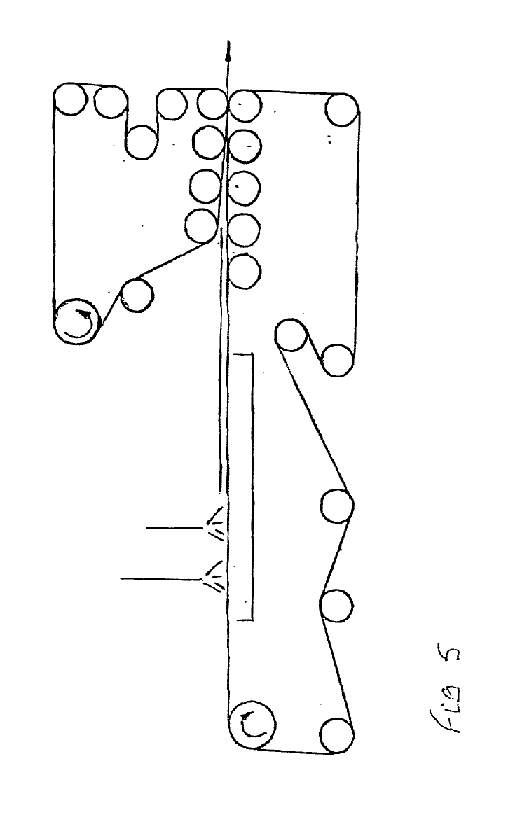

When suspended over rollers, a source or sources of cellulose or synthetic fibers, or cellulose particles, deposits a layer on the screen surface as shown in FIGS. 4 and 5. The filter screen separates the fiber from the carrier fluid while transporting the layer across the machine. At some point in the process the fiber is removed from the screen, either by transfer to a drum as in FIG. 4 or direct discharge as in FIG. 5. At high speed the forces generated by uneven forces at the suction box or guide roll may become sufficient to twist the screen, causing corrugations or a crash into the frame of the machine which again may cause a catastrophic failure.

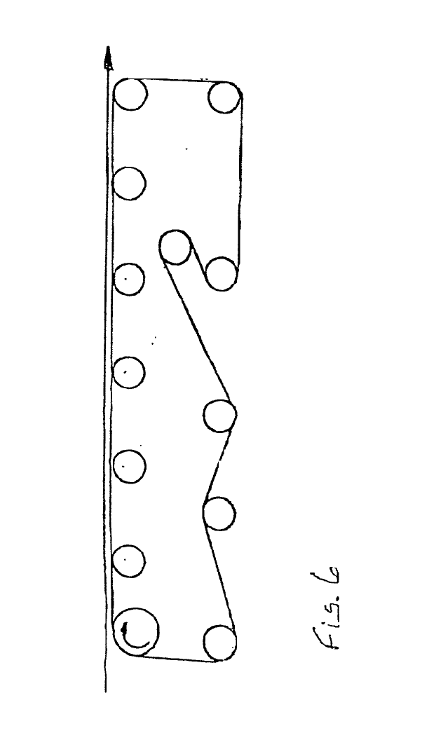

FIG. 6 illustrates a carrier belt moving formed material through the production process. Uneven loading, or malfunction of the guidance system, may allow the belt to move into frame of the machine causing catastrophic damage.

The introduction of stiff filaments, either by brazing or welding, or the addition at weaving or later, increases the resistance to skewing and arcing, thereby prolonging the useful life of the filter screen.

Generally, the stiffness is increased so that deflection of the screen will be reduced 50% or more.

The stiff reinforcing strands are generally made of the same material as but heavier gauge than the screen material, e.g., if the screen is made of stainless steel, the reinforcing strands would also be made of stainless steel but of heavier gauge than the wires of the screen.

Spacing of the reinforcing strands in either the cross machine direction or the machine direction of the screen need not depend on the size of the screen. For example, whether the screen is 40 feet long and 24 feet wide or 150 feet long and 10 feet wide, spacing ranges from 4 feet to 9 feet or more, preferably from 5 feet to 8 feet, in each direction. The spacing in the cross machine direction need not be the same as in the machine direction.

The contents of U.S. Pat. No. 5,373,615 to Ian Webb is incorporated hereinto by this reference thereto.

What is claimed is:

1. A filter screen for use in pulp production comprising a woven mesh of metal wires with reinforcing filaments, regularly spaced, in the cross machine and machine directions.

2. The invention as claimed in claim 1, wherein said reinforcing filaments are produced by brazing.

3. The invention as claimed in claim 1, wherein said reinforcing filaments are produced by welding.

4. The invention as claimed in claim 1, wherein said reinforcing filaments are produced during weaving.

5. The invention as claimed in claim 1, wherein said reinforcing filaments are added after weaving.

6. A filter screen for use in pulp production comprising a woven synthetic fabric with reinforcing filaments, regularly spaced, in the cross machine and machine directions.

7. The invention as claimed in claim 6, wherein said reinforcing filaments are produced during weaving.

8. The invention as claimed in claim 6, wherein said reinforcing filaments are added after weaving.

9. A filter screen for use in material formation comprising a woven mesh of metal wires with reinforcing filaments, regularly spaced, in the cross machine and machine directions.

10. The invention as claimed in claim 9, wherein said reinforcing filaments are produced by brazing.

11. The invention as claimed in claim 9, wherein said reinforcing filaments are produced by welding.

12. The invention as claimed in claim 9, wherein said reinforcing filaments are produced during weaving.

13. The invention as claimed in claim 9, wherein said reinforcing filaments are added after weaving.

14. A filter screen for use in fabric formation comprising a woven synthetic fabric with reinforcing filaments, regularly spaced, in the cross machine and machine directions.

15. The invention as claimed in claim 14, wherein said reinforcing filaments are produced during weaving.

16. The invention as claimed in claim 14, wherein said reinforcing filaments are added after weaving.

17. A filter screen for use in material transport comprising of a woven mesh of metal wires with reinforcing filaments, regularly spaced, in the cross machine and machine directions.

18. The invention as claimed in claim 17, wherein said reinforcing filaments are produced by brazing.

19. The invention as claimed in claim 17, wherein said reinforcing filaments are produced by welding.

20. The invention as claimed in claim 17, wherein said reinforcing filaments are produced during weaving.

21. The invention as claimed in claim 17, wherein said reinforcing filaments are added after weaving.

22. A filter screen for use in fabric formation comprising a woven synthetic fabric with reinforcing filaments, regularly spaced, in the cross machine and machine directions.

23. The invention as claimed in claim 22, wherein said reinforcing filaments are produced during weaving.

24. The invention as claimed in claim 22, wherein said reinforcing filaments are added after weaving.
